(19) United States
(12) Patent Application Publication
(10) Pub. No.: US 2025/0222990 A1
(43) Pub. Date: Jul. 10, 2025

(54) CORE REPAIR OF A CORE STRUCTURE PANEL USING A TRIPLY PERIODIC MINIMAL SURFACE STRUCTURE

(71) Applicant: THE BOEING COMPANY, Arlington, VA (US)

(72) Inventors: Dylan Reuel Weber, Hermosa Beach, CA (US); Jay Patel, Irvine, CA (US)

(21) Appl. No.: 18/404,574

(22) Filed: Jan. 4, 2024

(51) Int. Cl. B62D 27/02; B32B 3/08; B32B 5/18; B32B 7/12; B60S 5/00

(52) U.S. Cl. CPC B62D 27/026; B32B 3/08; B32B 5/18; B32B 7/12; B32B 2250/40; B32B 2307/722; B32B 2605/00; B60S 5/00

(57) ABSTRACT

A method includes forming an opening in a core structure panel. The opening extends through a first laminate skin and at least partially through a core of the core structure panel. The method includes positioning a core repair plug in the opening. The core repair plug comprises a triply periodic minimal surface (TPMS) structure to replace the core removed during formation of the opening. The method includes adhering the TPMS structure to the core adjacent to the opening. The method also includes repairing the first laminate skin.

### FIELD OF THE DISCLOSURE

The present disclosure is generally related to a core structure repair of a core structure panel using a triply periodic minimal surface structure.

### BACKGROUND

Core structure panels include skins on each side of a low-density core material (e.g., fiberglass, carbon fiber reinforced polymer, nomex aramide paper, aluminum, etc.). The core material is often a honeycomb core. Impact against the core structure panel can cause inconsistencies in the core. A lightning strike can create inconsistencies in one or both skins and a core of the core structure panel. A core of a core structure panel may also be susceptible to water inconsistencies. Inconsistencies in the core can affect the mechanical properties of the core structure panel. When a core structure panel has core inconsistencies, a portion of the core structure panel can be removed and replaced with a core plug. Typically, the core plug is the same type of material and structure as the core of the core structure panel. It is desirable to have a core plug with better mechanical properties and water tolerance than the removed material.

### SUMMARY

In a particular implementation, a core structure panel includes a first laminate skin and a second laminate skin. The core structure panel includes a core between the first laminate skin and the second laminate skin. The core structure panel also includes a triply periodic minimal surface (TPMS) structure adhered to a portion of the core.

In another particular implementation, a vehicle includes a first laminate skin and a second laminate skin. The vehicle includes a core between the first laminate skin and the second laminate skin. The vehicle also includes a TPMS structure adhered to a portion of the core.

In another particular implementation, a method includes forming an opening in a core structure panel. The opening extends through a first laminate skin and at least partially through a core of the core structure panel. The method includes positioning a core plug in the opening. The core plug comprises a TPMS structure to replace the core removed during formation of the opening. The method includes adhering the TPMS structure to the core adjacent to the opening. The method also includes repairing the first laminate skin.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 depicts a perspective representation of a unit cell of a gyroid TPMS structure.

FIG. 2 depicts a perspective representation of a unit cell of a Fischer-Koch S surface TPMS structure.

FIG. 3 depicts a perspective representation of a unit cell of a PMY TPMS structure.

FIG. 4 depicts a perspective representation of a TPMS structure with a density gradient.

FIG. 5 depicts a cross-sectional representation of a portion of a core structure panel with a TPMS structure that is a full depth replacement of a portion of a core of the core structure panel.

FIG. 6 depicts an exploded view of a system for repair of a portion of the core structure panel of FIG. 5 prior to placement of components of a repair patch used to repair the core structure panel in, or on, the core structure panel.

FIG. 7 depicts a cross-sectional representation of a portion of a core structure panel with a TPMS structure that is a partial depth replacement of a portion of a core of the core structure panel.

FIG. 8 is a block diagram representation of a system to repair a core structure panel.

FIG. 9 is a flow chart of an example method for repairing a core structure panel with a repair patch.

### DETAILED DESCRIPTION

Aspects disclosed herein present systems and methods for repair of a core of a core structure panel having a core (e.g., a honeycomb core) sandwiched between a first laminate skin and a second laminate skin. Particular procedures and specifications for repair of the core structure panel may be detailed in a structural repair manual (SRM) associated with the core structure panel (e.g., a SRM for an aircraft that includes the core structure panel).

An area of a core to be repaired is determined using a nondestructive testing method (e.g., visual inspection, tap testing, ultrasonic inspection, etc.) and a working area that is larger than the area to be repaired is marked on the first laminate skin. The first laminate skin and portions of the core to be repaired are removed in the working area using appropriate tools (e.g., drills, knives, chisels, cutters, grinders, etc.) to form an opening for a core plug.

The opening can have a circular shape, ovoid shape, or other type of shape. The opening can extend into the core structure panel a distance that exceeds a minimum distance (e.g., half an inch) for a partial depth replacement or can extend to the second laminate skin for a full depth replacement. A partial depth replacement may be performed when testing determines that a portion of the core has separated from one of the laminate skins of the core structure panel. When forming the opening, care is taken not to make inconsistencies in the second laminate skin if the opening extends to the second laminate skin. If the second laminate skin already has one or more inconsistencies, or one or more inconsistencies in the second skin are introduced during formation of the opening, the second laminate skin is repaired before repairing the core. The edges of first laminate skin are processed (e.g., sanded) to form a uniform taper around the opening for a subsequent repair of the first laminate skin. In some implementations, moisture in, and adjacent to, the opening is removed using an autoclave or vacuum bag procedure.

An adhesive film is positioned in the opening and a core plug is positioned in the opening on the adhesive film. The core plug includes a triply periodic minimal surface (TPMS) structure surrounded by a foam adhesive. In some implementations, the TPMS structure is generated by an additive manufacturing machine from a material different than the material that forms the core.

The TPMS structure is a sheet based TPMS structure formed using an additive manufacturing machine. Other types of TPMS structures include skeletal based TPMS structures and strut based TPMS structures. In some implementations, the TPMS structure is produced by the additive manufacturing machine to fit in the opening. In other implementations, the TPMS structure is preformed and cut to the size of the opening. The TPMS structure, one or more surfaces of the core structure panel defining the opening, or both, are subjected to a surface treatment to ensure that the TPMS structure is able to bond to the existing core via the foam adhesive and is able to bond to plies above and below the TPMS structure. Bonding of the TPMS structure with the core and the plies above and below the TPMS structure enables loads applied to the core structure panel to be transferred to the TPMS structure. For a TPMS structure formed of a polymer material, the surface treatment may be a plasma treatment (e.g., an atmospheric plasma treatment). For a TPMS structure formed of a metal, the surface treatment may include abrasion, plasma treatment, other treatment, or combinations thereof.

The core structure panel with the core plug positioned in the opening is subjected to a curing process to adhere the TPMS structure of the core plug to the core of the core structure panel via the foam adhesive and to adhere the TPMS structure to the second laminate skin via the adhesive layer. The core structure panel may be placed in an autoclave or subjected to a vacuum bag procedure, during the curing process to draw a vacuum on a portion of the core structure panel, to raise a temperature to a curing temperature, and to remove generated gas.

Subsequent to the curing process, the first laminate skin is repaired by forming a patch for the first laminate skin and curing the patch. The patch includes a filler ply if there is a space between the top of the core plug and a bottom of the first laminate skin, an adhesive film, repair plies that are oriented in directions corresponding to plies of the first laminate skin, one or more additional repair plies, and a nonstructural sanding ply. The core structure panel may be placed in an autoclave, or subjected to a vacuum bag procedure, during curing of the patch.

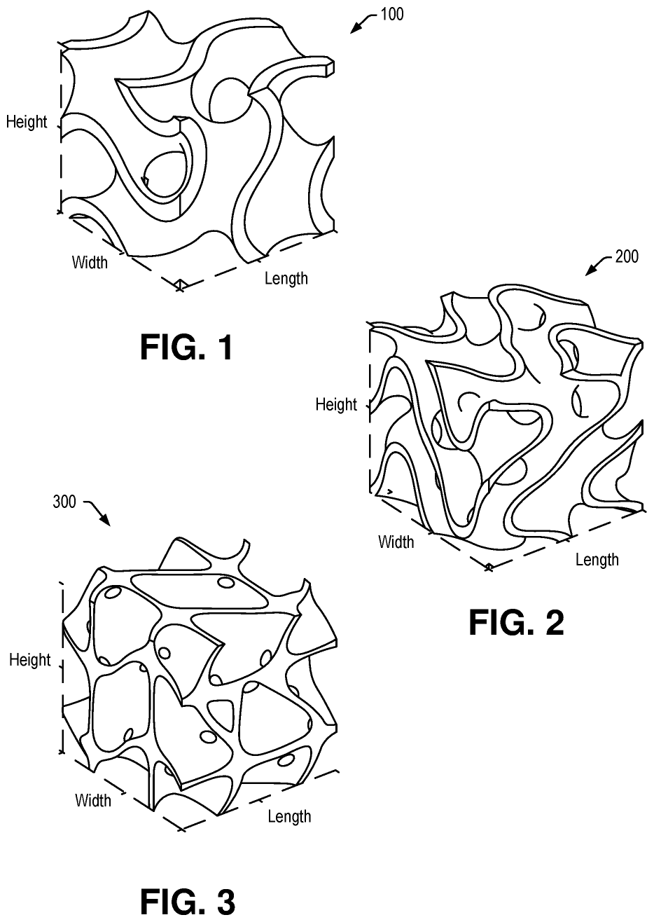

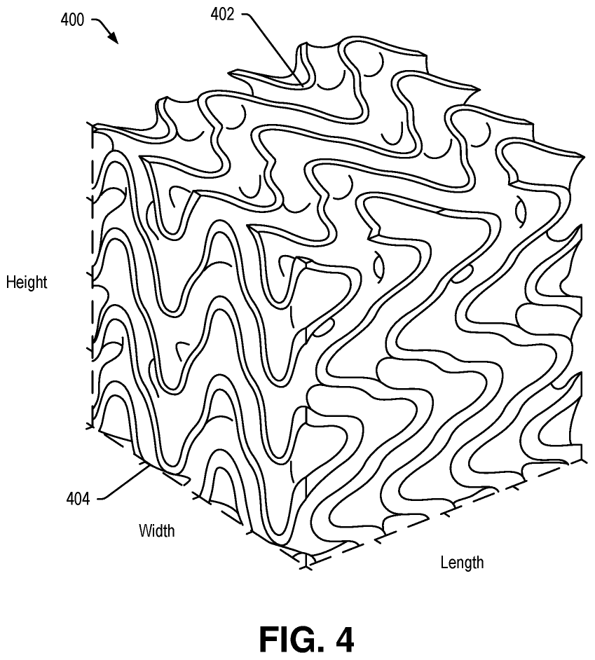

The core plug includes the TPMS structure. The TPMS structure has a minimal surface (i.e., a sum of principal curvatures at each point of a surface is, or is close to, zero so that there is substantially zero mean curvature) that repeats in three dimensions. FIGS. 1-3 depict perspective representations of unit cells of three types of TPMS structures. Height, width, and length axes are not physically present and so are depicted as broken lines in FIGS. 1-3. FIG. 1 depicts a TPMS structure 100 with a gyroid lattice structure, FIG. 2 depicts a TPMS structure 200 with a Fischer-Koch S surface lattice structure, and FIG. 3 depicts a TPMS structure 300 with a PMY lattice structure. Other types of TPMS structures may also be used as part of a core repair plug for the core structure panel. The TPMS structures can have uniform density in all directions, or the TPMS structures may be graded so that there is a density gradient in one or more particular directions (e.g., height). A particular type of TPMS structure to use as part of a core plug may be chosen based on mechanical properties of the TPMS structure (e.g., density, Young's modulus, energy absorption, etc.).

A technical advantage of using a TPMS structure to repair a core structure panel is that the TPMS structure can have better mechanical properties than the portion of the core being replaced. A TPMS structure can have a high Young's modulus, high impact resistance, and high energy absorption. TPMS structures without a density gradient exhibit isotropic behavior, so the TPMS structures are better able to handle applied stresses from all directions as compared to other structures. Some TPMS structures can be formed with a density gradient to better accommodate stresses and impacts applied from one or more particular directions. For example, FIG. 4 depicts a perspective view of a TPMS structure 400 with a density gradient. Height, width, and length axes are not physically present and so are depicted as broken lines in FIG. 4. Wall thickness of the TPMS structure 400 in a height-width plane increases from a top 402 of the TPMS structure 400 toward a bottom 404 of the TPMS structure 400 to produce the density gradient. In other implementations, wall thickness of a different plane, wall thickness of an additional plane, materials, or combinations thereof, may be adjusted to produce a desired density gradient.

The density gradient for a TPMS structure of a core plug may have a highest density at the laminate skins that decreases towards a center of the TPMS structure, may have a highest density near a laminate skin that is most likely to be subjected to an impact that decreases to the other laminate skin so that the TPMS structure is able to absorb energy of impact against the laminate skin, or may have a different type of density gradient. A material used to form a TPMS structure can have plasticity that provides the TPMS structure with the ability to elastically deform to absorb energy, which can inhibit buckling that can happen to a honeycomb core due to the application of a high axial load.

Use of a TPMS structure for repair of a core structure panel may have additional advantages over use of the same type of core of the core structure panel for repair of the core structure panel. Due to a material of the TPMS structure, due to the shape of a TPMS structure making a labyrinthian path between laminate skins, or both, the TPMS structure may not have the same issues with water ingression as compared to other types of cores. Also, a TPMS structure can advantageously be formed by an additive manufacturing machine to have particular properties (e.g., shape, unit cell size, density gradient, density, etc.) needed for repair of a particular core structure panel.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. For ease of reference herein, such features are generally introduced as “one or more” features and are subsequently referred to in the singular unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

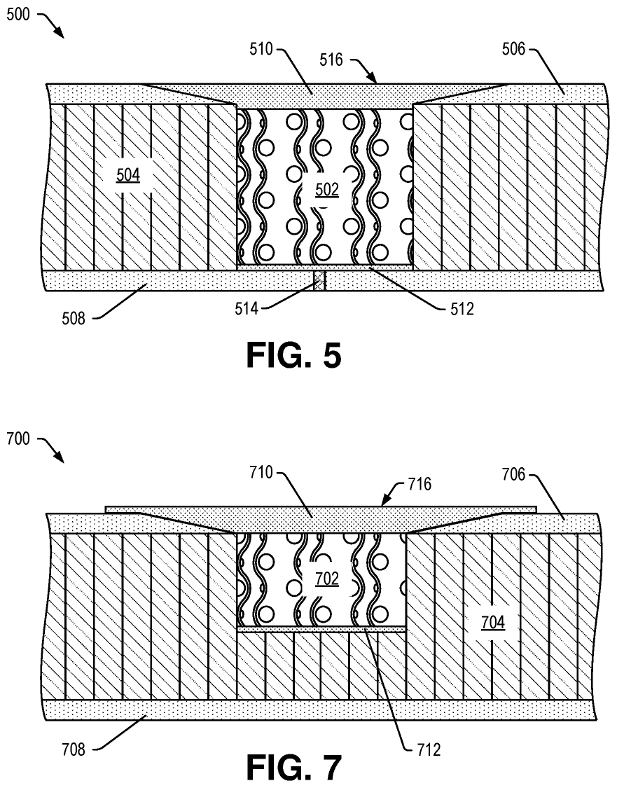

FIG. 5 depicts a cross-sectional representation of a portion of a core structure panel 500 with a TPMS structure 502 that is a full depth replacement of a portion of a core 504 of the core structure panel 500. The core 504 may be a honeycomb core or other type of core. The core structure panel 500 includes the TPMS structure 502, the core 504, a first laminate skin 506, a second laminate skin 508, a patch 510, and an adhesive layer 512 positioned between the TPMS structure 502 and the second laminate skin 508.

FIG. 5 also depicts a potted repair 514 in the second laminate skin 508. The potted repair 514 fixes a small opening in the second laminate skin 508. In an implementation, the potted repair 514 is an epoxy resin with glass fibers, other fillers, or combinations thereof, that is applied before repair of a portion of the core 504 of the core structure panel 500. In some implementations, no repair needs to be made to the second laminate skin 508. In other implementations, a larger opening in the second laminate skin is repaired with a patch similar to patch 510 before repair of the core 504.

The TPMS structure 502 is positioned in an opening formed in the core structure panel 500. The opening is formed to remove portions of the core 504 with one or more inconsistencies and to taper edges of the first laminate skin 506 to receive the patch 510. The TPMS structure 502 is part of a core plug inserted into the opening. The core plug includes the TPMS structure 502 and a foam adhesive positioned around the TPMS structure 502. The foam adhesive is activated during a curing process to adhere the TPMS structure 502 to the core 504. During the curing process, the TPMS structure 502 is adhered to the second laminate skin 508 via the adhesive layer 512. Subsequent to the curing process, or simultaneously with the curing process, the patch 510 is formed and cured to repair the first laminate skin 506. The TPMS structure 502 and the patch 510 form a repair patch 516 for a portion of the core structure panel 500 with one or more inconsistencies.

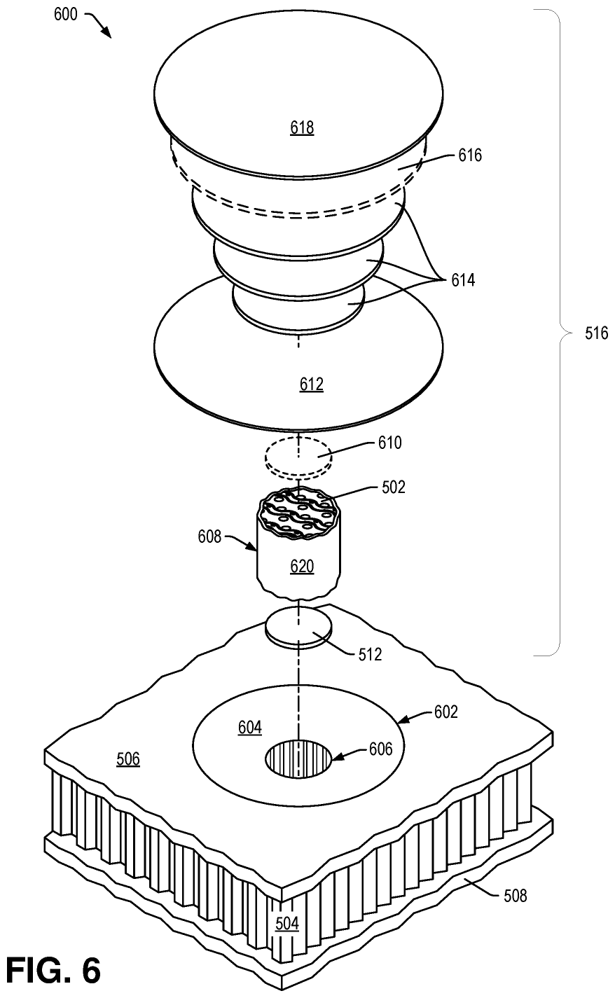

FIG. 6 depicts an exploded view of a system 600 for repair of a portion of the core structure panel 500 of FIG. 5 prior to placement of components of the repair patch 516 used to repair the core structure panel 500 in, or on, the core structure panel 500. The core structure panel 500 includes an opening 602 with a tapered portion 604 in the first laminate skin 506 and a central portion 606 that extends into the core 504 a desired depth (e.g., to the second laminate skin 508 for a full depth repair and to a particular depth for a partial depth repair).

The components of the repair patch 516 used to repair the core structure panel 500 include the adhesive layer 512, a core plug 608, one or more filler plies 610, an adhesive film 612, repair plies 614, one or more extra repair plies 616, a nonstructural sanding ply 618, other layers, or combinations thereof. The core plug 608 includes the TPMS structure 502 and a foam adhesive 620 around the TPMS structure 502.

The plies 610, 614, 616, 618 may be prepreg plies. The sanding ply 618 may be a glass fabric prepreg. The filler ply 610 and the extra repair ply 616 are optional and so are depicted in dashed lines in FIG. 6. The filler ply 610 is used when a top of the TPMS structure positioned in the central portion 606 of the opening 602 is below a bottom of the first laminate skin 506 and the shape of the filler ply 610 corresponds to a shape of the central portion 606. The extra repair ply 616 is used when specified in the structural repair manual associated with the core structure panel 500. The repair plies 614 correspond to plies of the first laminate skin 506 and are oriented as specified in the structural repair manual to correspond to orientation of plies used to form the first laminate skin 506.

FIG. 7 depicts a cross-sectional representation of a portion of a core structure panel 700 with a TPMS structure 702 that is a partial depth replacement of a portion of a core 704 of the core structure panel 700. The core 704 may be a honeycomb core or other type of core. The core structure panel 700 includes the core 704, a first laminate skin 706, and a second laminate skin 708.

Inconsistencies associated with a portion of the core 704 are repaired with a repair patch 716, and the repair patch 716 is a portion of the core structure panel 700. The repair patch 716 includes an adhesive layer 712 positioned between the TPMS structure 702 and the core 704, the TPMS structure 702, and a patch 710. A bottom surface of the TPMS structure 702 is adhered to the core 704 via the adhesive layer 712 and a foam adhesive around one or more side surfaces of the TPMS structure 702 also adhere the TPMS structure 702 to the core 704. The patch 710 is adhered to a top surface of the TPMS structure 702 and the first laminate skin 706. The patch is formed of an adhesive film; repair plies that correspond to, and are oriented in the same directions as, plies that form the first laminate skin 706; one or more extra repair plies adhered to the first laminate skin 706 via the adhesive film and adhered to an upper repair ply of the repair plies; and a sanding ply. The sanding ply may be removed or substantially removed by sanding during a finishing process of forming the repair patch 716. In an implementation, a first curing process is used to adhere the TPMS structure 702 to the core 704 via the adhesive layer 712 and an adhesive foam around the TPMS structure 702, and a second curing process is used to adhere the components of the patch 710 to the TPMS structure 702 and to the first laminate skin 706.

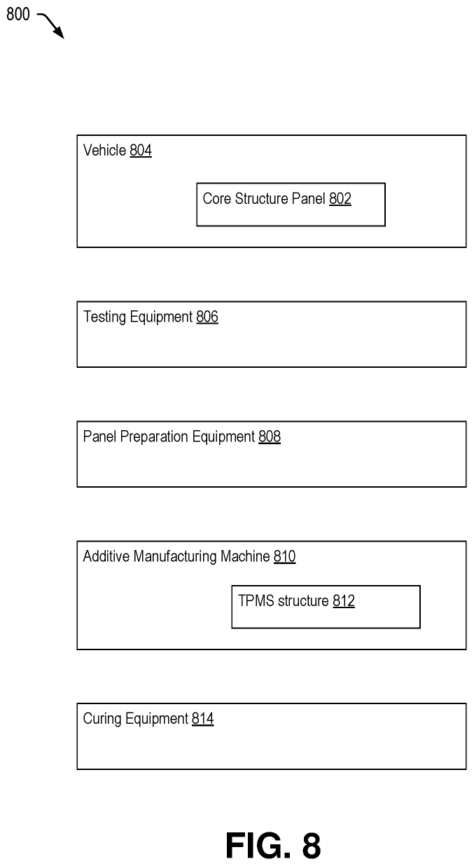

FIG. 8 depicts a block diagram representation of a system 800 to repair a core structure panel 802 (e.g., the core structure panel 500 of FIG. 5 or the core structure panel 700 of FIG. 7). The core structure panel 802 may be a portion of a vehicle 804 (e.g., an aircraft, automobile, watercraft, or combination thereof). In some implementations, the core structure panel 802 may be a portion of an outer surface of the vehicle 804. In some implementations, the core structure panel 802 is removed from the vehicle before being repaired, and in other implementations, the core structure panel 802 is repaired while remaining attached to the vehicle 804. During a lifetime of the vehicle 804, the core structure panel 802 may be subject to one or more events that could cause inconsistencies in the core structure panel 802.

When the core structure panel 802 is suspected to have one or more inconsistencies (e.g., due to impact, a lightning strike, suspected water ingress, etc.), a visual inspection, testing equipment 806, or both, may be used to determine whether the core structure panel 802 has one or more inconsistencies and whether the one or more inconsistencies includes one or more inconsistencies associated with a core of the core structure panel 802. The testing equipment may include tap instruments used by an inspector to detect for inconsistencies based on sound changes in different areas of the core structure panel 802, ultrasound devices, moisture detectors, and other non-invasive testing devices. When the core structure panel 802 has one or more inconsistencies, a working area that defines an extent of the core structure panel 802 with one or more inconsistencies may be marked on a skin of the core structure panel 802.

Panel preparation equipment 808 is used to prepare the core structure panel 802 for repair. The panel preparation equipment may include one or more knives, grinders, shears, sanders, cleaning tools (e.g., a vacuum to remove small cuttings, a plasma device for atmospheric plasma treatment of surfaces, cleaning fluids, etc.), and other tools to form an opening in the core structure panel 802 through a skin of the core structure panel 802, to remove core material with one or more inconsistencies, and to prepare surfaces for repairing the core structure panel 802.

The system 800 includes an additive manufacturing machine 810 to generate a TPMS structure 812 used as a core repair. In some implementations, the additive manufacturing machine generates the TPMS structure 812 based on dimensions of the opening formed in the core structure panel 802. In other implementations, the TPMS structure 812 is cut from a sheet of pre-formed TPMS structure.

The system 800 also includes curing equipment 814 to cure (e.g., chemically react) portions of a repair patch to repair the one or more inconsistencies of the core structure panel 802. The curing equipment 814 may also be used to apply heat, a vacuum, or both, to remove moisture from a treatment area of the core structure panel 802 to be repaired before a core plug including the TPMS structure 812 that replaces portions of the core with one or more inconsistencies is positioned in the core structure panel 802. The curing equipment 814 may be an autoclave for smaller core structure panels 802. For large core structure panels 802 and for repairs performed on vehicles 804 that will not fit in available autoclaves, vacuum bag procedures are utilized to apply heat, vacuum, or both to treatment areas. A vacuum bag procedure may utilize one or more thermocouples, breather cloths, one or more heat blankets, pressure gauges, an interface to a treatment area, and bag material sealed to the interface and the core structure panels 802 to allow vacuum and heat to be applied to the treatment area.

In addition to testing the core structure panel 802 to determine portions of the core structure panel 802 with one or more inconsistencies, the testing equipment 806 is used for post repair inspection. Visual inspection, tap inspection, ultrasonic inspection, other types of non-destructive inspection, or combinations thereof, may be performed to ensure that the repair patch is satisfactory. In addition, for some implementations, one or more additional tests performable using the testing equipment 806 (e.g., a balance check) are performed to ensure that the patch repair is within specifications provided in the structural repair manual associated with the core structure panel 802.

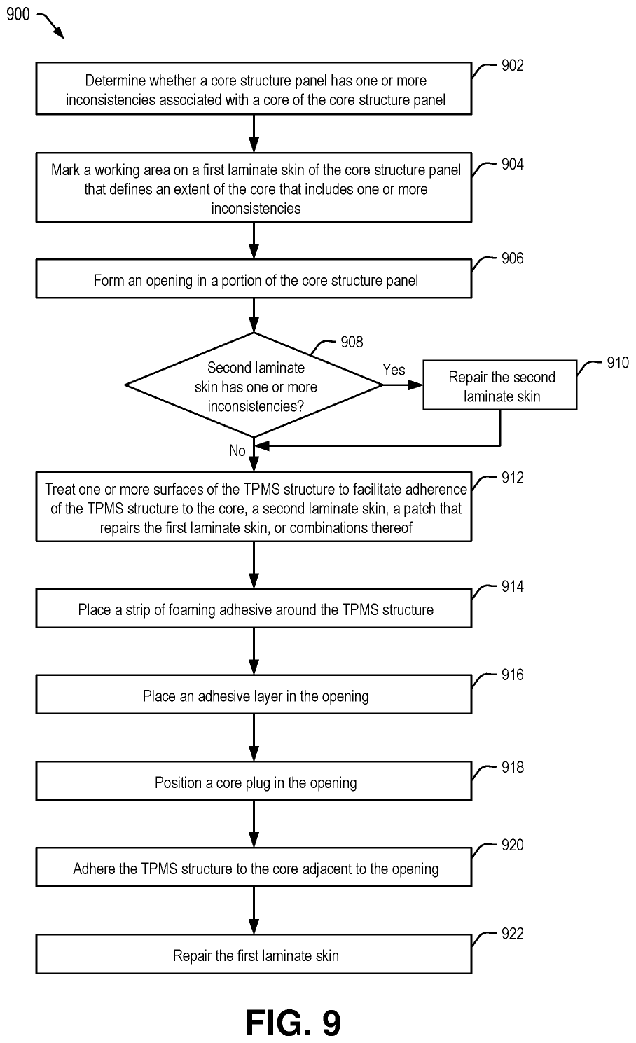

FIG. 9 is a flow chart of an example method 900 for repairing a core structure panel with a repair patch. The core structure panel may be the core structure panel 500 depicted in FIG. 5 and FIG. 6, or the core structure panel 700 depicted in FIG. 7. The repair patch may be the repair patch 516 depicted in FIG. 5 and FIG. 6, or the repair patch 716 depicted in FIG. 7. The method may be performed using the system 800 depicted in FIG. 8. The method 900, at block 902, includes determining whether a core structure panel 500, 700 has one or more inconsistencies associated with a core of the core structure panel 500, 700. In some implementations, visual inspection, testing performed using the testing equipment 806, or both, are used to determine if the core structure panel 500, 700 has one or more inconsistencies. If both laminate skins 506, 508, include openings to the core 504, the opening in the laminate skin 508 is repaired. For example, the core structure panel 500 included openings to the core 504 in both laminate skins 506, 508, and the opening in the second laminate skin 508 was repaired with the potted repair 514.

The method 900, at block 904, includes marking a working area on a first laminate skin 506, 706 of the core structure panel 500, 700 that defines an extent of the core 504 that includes one or more inconsistencies. In an implementation, the working area is marked on the first laminate skin 506, 706. The working area includes all portions of the core 504, 704 with the one or more inconsistencies and can include portions of the core 504, 704 surrounding the portions with one or more inconsistencies to ensure that all portions of the core with inconsistencies are repaired.

The method 900, at block 906, includes forming an opening 602 in the core structure panel 500, 700, where the opening 602 extends through the first laminate skin 506, 706 and at least partially through the core 504, 704. Formation of the opening 602 removes portions of the core structure panel 500, 700 with one or more inconsistencies, including portions of the first laminate skin 506, 706 with one or more inconsistencies, and portions of the core 504, 704 with one or more inconsistencies. Formation of the opening 602 removes a portion of the core 504 in the working area. In an implementation, the opening 602 includes the tapered portion 604 in the first laminate skin 506, 706 and the central portion 606 that extends into the core 504, 704. The central portion 606 can extend to the second laminate skin 508 when the repair is a full depth repair, as depicted in FIG. 5, or the central portion 606 can extend a particular depth into the core 704 beyond a minimal depth when the repair is a partial depth repair, as in FIG. 7. Debris in the opening 602 is removed and the surfaces that define the central portion 606 can be cleaned, surface treated, or both, to facilitate adherence with a core plug 608 positioned in the central portion 606.

The method 900, at decision block 908, includes determining if the second laminate skin 508, 708 has one or more inconsistencies. If the second laminate skin 508, 708 has one or more inconsistencies, the method 900, at block 910, includes repairing the second laminate skin 508, 708. For example, a repair of the second laminate skin 508 may be a potted repair 514 for small sized inconsistencies in the second laminate skin 508, 708 (e.g., inconsistencies with lengths less than a half an inch) or a patch for more extensive inconsistencies in the second laminate skin 508.

After block 910 or when the decision block 908 indicates the second skin 508, 708 has no inconsistencies, the method 900, at block 912, includes treating one or more surfaces of a TPMS structure 502, 702. The TPMS structure 502, 702 replaces portions of the core 504, 704 removed during formation of the opening 602. Treating one or more surfaces of the TPMS structure 502, 702 facilitates adherence of the TPMS structure 502, 702 to the core 504, 704, a second laminate skin 508, 708, a patch 510, 710 that repairs the first laminate skin 506, 706, or combinations thereof. The TPMS structure 502, 702 may be formed by the additive manufacturing machine 810. When the TPMS structure 502, 702 is made from a polymer material, treatment of the surface may include exposing the surface to plasma (e.g., atmospheric plasma) via a nozzle of a cleaning tool of the preparation equipment 808 to clean and activate the surface (e.g., convert a low energy surface to a higher energy surface by attaching polar molecules to the surface). When the TPMS structure 502, 702 is formed of metal, treatment of the metal may include abrasion, exposing the surface to plasma (e.g., atmospheric plasma), other treatment, or combinations thereof.

The method 900, at block 914, includes placing a strip of foaming adhesive 620 around the TPMS structure 502, 702 to form a core plug 608. The foaming adhesive 620 enables the TPMS structure 502 to adhere to the core 504 of the core structure panel 500. The method 900, at block 916, includes placing an adhesive layer 512, 712 in the central portion 606 of the opening 602. The adhesive layer 512, 712 enables a bottom of the core plug 608 to adhere to the second laminate skin 508 when the repair is a full depth repair or enables the bottom of the core plug 608 to adhere to the core 704 when the repair is a partial depth repair.

The method 900, at block 918, includes positioning the core plug 608 in the opening 602. The method 900, at block 920, includes adhering the TPMS structure 502, 702 to the core 504, 704 adjacent to the opening 602. A curing process is implemented to adhere the TPMS structure 502, 702 to the core 504 via the foam adhesive 620 and to adhere the bottom of the TPMS structure 502, 702 to the second laminate skin 508 via the adhesive layer 512 for a full depth repair or to the core 704 via the adhesive layer 712 for a partial depth repair. The curing process is implemented using the curing equipment 814 to draw a vacuum and heat the foam adhesive 620 and the adhesive layer 512, 712 to a curing temperature.

The method 900, at block 922, also includes repairing the first laminate skin 506, 706. Repairing the first laminate skin 506, 706 includes placing a filler ply 610 on top of the TPMS structure 502, 702 if a top of the TPMS structure 502, 702 is below a bottom of the first laminate skin 506, 706. If the top of the TPMS structure 502, 702 is above the bottom of the first laminate skin 506, 706, the top of the TPMS structure 502, 702 is ground down to be at the height of the bottom of the first laminate skin 506, 706. An adhesive film 612 is positioned to cover the remaining portions of the opening 602 and a portion of the first laminate skin 506, 706 surrounding the opening 602. Plies 614, 616, 618 are positioned on the adhesive film 612. A curing process is implemented to cure the adhesive film 612 and the plies 610, 614, 616, 618 to form the patch 510, 710 that adheres to the TPMS structure 502, 702 and the first laminate skin 506, 706. After the curing process, a finishing process is implemented to provide appropriate surface characteristics to the patch 510, 710, and the testing equipment 806 can be used to determine that the repair of the core structure panel 500, 700 is a satisfactory repair.

Although the method 900 is illustrated as including a certain number of steps, more, fewer, and/or different steps can be included in the method 900 without departing from the scope of the subject disclosure. For example, the decision block 908 can be performed before forming the opening 602 when the repair is a partial depth repair, and before and after forming the opening 602 when the repair is a full depth repair.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. As a further example, the drawings are conceptual and are not drawn to scale. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features can be grouped together or described in a single implementation for the purpose of streamlining the disclosure. Examples described above illustrate but do not limit the disclosure. It should also be understood that numerous modifications and variations are possible in accordance with the principles of the subject disclosure. As the following claims reflect, the claimed subject matter can be directed to less than all of the features of any of the disclosed examples. Accordingly, the scope of the disclosure is defined by the following claims and their equivalents.

Further, the disclosure comprises embodiments according to the following Examples:

According to Example 1, a core structure panel includes a first laminate skin; a second laminate skin; a core between the first laminate skin and the second laminate skin; and a triply periodic minimal surface (TPMS) structure adhered to a portion of the core.

Example 2 includes the core structure panel of Example 1, wherein a foam adhesive adheres the TPMS structure to the portion.

Example 3 includes the core structure panel of Example 1 or Example 2, wherein a lattice of the TPMS structure is a sheet based TPMS.

Example 4 includes the core structure panel of any of Example 1 to Example 3, wherein the TPMS structure is a component of a repair patch for a portion of the core structure panel with one or more inconsistencies.

Example 5 includes the core structure panel of Example 4, wherein the repair patch includes a ply of adhesive film coupled to the second laminate skin, the TPMS structure, a foam adhesive coupled to the TPMS structure, an adhesive film, a plurality of repair plies corresponding to the first laminate skin, one or more extra repair plies, a sanding ply, or combinations thereof.

Example 6 includes the core structure panel of Example 5, further comprising a filler ply to fill a gap between a surface of the TPMS structure and the first laminate skin.

Example 7 includes the core structure panel of Example 5 or Example 6, wherein a first curing process is used to adhere the TPMS structure to the first laminate skin via the ply of adhesive film and to adhere the TPMS structure to the portion via the foam adhesive.

Example 8 includes the core structure panel of any of Example 1 to Example 7, wherein the TPMS structure has a density gradient.

Example 9 includes the core structure panel of any of Example 1 to Example 8, wherein the TPMS structure has a first density near the first laminate skin, a second density near the second laminate skin, and wherein density decreases from the first density and the second density toward a center of the TPMS structure.

Example 10 includes the core structure panel of any of Example 1 to Example 8, wherein the TPMS structure has a first density near the first laminate skin, a second density near the second laminate skin that is less than the first density, and wherein density decreases from the first density to the second density across the TPMS structure.

According to Example 11, a vehicle includes a first laminate skin; a second laminate skin; a core between the first laminate skin and the second laminate skin; and a triply periodic minimal surface (TPMS) structure adhered to a portion of the core.

Example 12 includes the vehicle of Example 11, wherein the TPMS structure comprises metal or a polymer material produced by an additive manufacturing machine.

Example 13 includes the vehicle of Example 11 or Example 12, wherein a foam adhesive adheres the TPMS structure to the portion.

Example 14 includes the vehicle of any of Example 11 to Example 13, wherein the TPMS structure is a component of a repair patch for a portion of the core with one or more inconsistencies.

Example 15 includes the vehicle of Example 14, wherein the repair patch includes a ply of adhesive film coupled to the second laminate skin, the TPMS structure, a foam adhesive coupled to the TPMS structure, a filler ply to fill a gap between a surface of the TPMS structure and the first laminate skin, an adhesive film, a plurality of repair plies corresponding to the first laminate skin, one or more extra repair plies, a sanding ply, or combinations thereof.

According to Example 16, a method includes forming an opening in a core structure panel, the opening extending through a first laminate skin and at least partially through a core of the core structure panel; the opening extending through a first laminate skin and at least partially through a core of the core structure panel; positioning a core plug in the opening, wherein the core plug comprises a triply periodic minimal surface (TPMS) structure to replace the core removed during formation of the opening; adhering the TPMS structure to the core adjacent to the opening; and repairing the first laminate skin.

Example 17 includes the method of Example 16, and further includes treating surfaces of the TPMS structure with plasma prior to said adhering the TPMS structure to the core.

Example 18 includes the method of Example 16 or Example 17, wherein said forming the opening includes removing a portion of the core structure panel with one or more inconsistencies.

Example 19 includes the method of any of Example 16 to Example 18, wherein said adhering the TPMS structure to the core comprises curing a foam adhesive between the TPMS structure and the core.

Example 20 includes the method of any of Example 16 to Example 19, and further includes repairing a portion of a second laminate skin with one more inconsistencies.

What is claimed is:

1. A core structure panel comprising:
a first laminate skin;
a second laminate skin;
a core between the first laminate skin and the second laminate skin; and
a triply periodic minimal surface (TPMS) structure adhered to a portion of the core.

2. The core structure panel of claim 1, wherein a foam adhesive adheres the TPMS structure to the portion.

3. The core structure panel of claim 1, wherein a lattice of the TPMS structure is a sheet based TPMS.

4. The core structure panel of claim 1, wherein the TPMS structure is a component of a repair patch for a portion of the core structure panel with one or more inconsistencies.

5. The core structure panel of claim 4, wherein the repair patch includes a ply of adhesive film coupled to the second laminate skin, the TPMS structure, a foam adhesive coupled to the TPMS structure, an adhesive film, a plurality of repair plies corresponding to the first laminate skin, one or more extra repair plies, a sanding ply, or combinations thereof.

6. The core structure panel of claim 5, further comprising a filler ply to fill a gap between a surface of the TPMS structure and the first laminate skin.

7. The core structure panel of claim 5, wherein a first curing process is used to adhere the TPMS structure to the first laminate skin via the ply of adhesive film and to adhere the TPMS structure to the portion via the foam adhesive.

8. The core structure panel of claim 1, wherein the TPMS structure has a density gradient.

9. The core structure panel of claim 1, wherein the TPMS structure has a first density near the first laminate skin, a second density near the second laminate skin, and wherein density decreases from the first density and the second density toward a center of the TPMS structure.

10. The core structure panel of claim 1, wherein the TPMS structure has a first density near the first laminate skin, a second density near the second laminate skin that is less than the first density, and wherein density decreases from the first density to the second density across the TPMS structure.

11. A vehicle comprising:
a first laminate skin;
a second laminate skin;
a core between the first laminate skin and the second laminate skin; and
a triply periodic minimal surface (TPMS) structure adhered to a portion of the core.

12. The vehicle of claim 11, wherein the TPMS structure comprises metal or a polymer material produced by an additive manufacturing machine.

13. The vehicle of claim 11, wherein a foam adhesive adheres the TPMS structure to the portion.

14. The vehicle of claim 11, wherein the TPMS structure is a component of a repair patch for a portion of the core with one or more inconsistencies.

15. The vehicle of claim 14, wherein the repair patch includes a ply of adhesive film coupled to the second laminate skin, the TPMS structure, a foam adhesive coupled to the TPMS structure, a filler ply to fill a gap between a surface of the TPMS structure and the first laminate skin, an adhesive film, a plurality of repair plies corresponding to the first laminate skin, one or more extra repair plies, a sanding ply, or combinations thereof.

16. A method comprising:
forming an opening in a core structure panel, the opening extending through a first laminate skin and at least partially through a core of the core structure panel;
positioning a core plug in the opening, wherein the core plug comprises a triply periodic minimal surface (TPMS) structure to replace the core removed during formation of the opening;
adhering the TPMS structure to the core adjacent to the opening; and
repairing the first laminate skin.

17. The method of claim 16, further comprising treating surfaces of the TPMS structure with plasma prior to said adhering the TPMS structure to the core.

18. The method of claim 16, wherein said forming the opening includes removing a portion of the core structure panel with one or more inconsistencies.

19. The method of claim 16, wherein said adhering the TPMS structure to the core comprises curing a foam adhesive between the TPMS structure and the core.

20. The method of claim 16, further comprising repairing a portion of a second laminate skin with one or more inconsistencies.
